(19) United States
(12) Patent Application Publication
(10) Pub. No.: US 2025/0263181 A1
(43) Pub. Date: Aug. 21, 2025

(54) IN-SITU APPLICATION OF ADAPTIVE LEVELS OF ENERGY APPLIED TO A SUBSET OF INDIGENOUS PARTICULATE TO FORM STRUCTURES IN A VACUUM

(71) Applicant: ICON Technology, Inc., Austin, TX (US)

(72) Inventors: Eamon Carrig, Austin, TX (US); Evan Jensen, Austin, TX (US); Alexander Le Roux, Austin, TX (US); Cody Eli Bressler, Austin, TX (US); Andy McEvoy, Austin, TX (US); Thao Nguyen, Austin, TX (US); Martyn Staalsen, Austin, TX (US)

(73) Assignee: ICON Technology, Inc., Austin, TX (US)

(21) Appl. No.: 18/444,565

(22) Filed: Feb. 16, 2024

(51) Int. Cl. B64G 99/00; B33Y 10/00; B33Y 30/00; E04G 21/04

(52) U.S. Cl. CPC B64G 99/00; E04G 21/04; B33Y 10/00; B33Y 30/00

(57) ABSTRACT

Various embodiments relate generally to additive manufacturing and construction techniques to form structures with embodiments directed to computer software and systems, and control systems, and, more specifically, to a computing and a mechanical platform configured to implement local material to form a structure by selecting or filtering a subset of particulate that is deposited in a form at which adaptive levels of energy are applied to construct structures in-situ in a vacuum additively (e.g., three-dimensionally, or in “3D”), whereby adaptive levels of energy may be generated by one or more lasers and may be configurable to control temperatures associated with, for example, crystallization of indigenous particulate.

### FIELD

Various embodiments relate generally to additive manufacturing and construction techniques to form structures with embodiments directed to computer software and systems, and control systems, and, more specifically, to a computing and a mechanical platform configured to implement local material to form a structure by selecting or filtering a subset of particulate that is deposited in a form at which adaptive levels of energy are applied to construct structures in-situ in a vacuum additively (e.g., three-dimensionally, or in “3D”), whereby adaptive levels of energy may be generated by one or more lasers and may be configurable to control temperatures associated with, for example, crystallization of indigenous particulate.

### BACKGROUND

Advances in robotics, computing hardware, software, and material science has contributed to various improvements to provide materials for construction of any type of structure, such as a wall, by using one or more viscous materials to form a “bead” or a longitudinally formed material.

Generally, typical construction techniques are directed to employ one or more materials local to a worksite at which to construct a structure having vertical dimensions, such as a wall, or horizontal dimensions, such as slab or a floor. But types and qualities of materials at certain locations present challenges on implementing indigenous construction materials suitable for additively forming structures, such as three-dimensional printed structures (e.g., “3D” printed structures). While some conventional approaches are functional in some environments, such approaches are not well-suited for other environments. Specifically, various conventional approaches to forming 3D structures implementing terrestrial materials are generally ill-suited for using materials that are other than terrestrial.

Some conventional approaches to using non-terrestrial (e.g., “off planet”) materials, or simulants thereof-including lunar simulants, have yet to be shown as optimal approaches to additive construction of structures. As an example, using known binder-based mortars with non-terrestrial materials are generally sub-optimum for forming structures in-situ. Moreover, known selective laser sintering (“SLS”) techniques are usually restricted to terrestrial use (e.g., in terms of gravity, atmospheric pressures levels, temperatures, etc.) and are directed to known characteristics (e.g., known sizes, known material compositions, etc.) of a material used. Thus, such terrestrial-limited approaches do not implement materials in-situ and likely are not adapted for non-terrestrial uses.

Thus, what is needed is a solution to forming structures implementing non-terrestrial materials in a vacuum, without the limitations of conventional techniques.

### BRIEF DESCRIPTION OF THE DRAWINGS

Various embodiments or examples (“examples”) of the invention are disclosed in the following detailed description and the accompanying drawings:

FIG. 1 is a diagram depicting an example of a device configured to implement a subset of indigenous particulate to form a structure in-situ, according to some embodiments;

FIG. 2 is a diagram depicting an example of an integrated end effector coupled to a robotic articulator, according to at least one example;

FIG. 3 is a perspective view of an example of an integrated end effector, according to some embodiments;

FIG. 4 illustrates an example of a thermal profile for a layer of particulate during application of laser energy, according to some examples;

FIGS. 5A and 5B depict exemplary structures or sub-structures additively constructed, according to some examples;

FIG. 6 depicts an example flow with which to form a structure or sub-structure, according to some embodiments;

FIG. 7 depicts another example flow with which to form multiple structures or sub-structures, according to some embodiments;

FIG. 8 illustrates an exemplary application architecture for controlling in-situ application of adaptive levels of energy applied to a subset of indigenous particulate to form structures in a vacuum, according to some examples; and

FIG. 9 illustrates examples of various computing platforms configured to provide various functionalities to components of a computing platform configured to provide functionalities described herein.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links including wireless transmissions between earth and off-planet computing devices. In general, operations of disclosed processes may be performed in any arbitrary order, unless otherwise provided in the claims.

A detailed description of one or more examples is provided below along with accompanying figures. The detailed description is provided in connection with examples and is not limited to any particular example. The scope is limited only by the claims, and numerous alternatives, modifications, and equivalents thereof. Numerous specific details are set forth in the following description to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description or providing unnecessary details that may be already known to those of ordinary skill in the art.

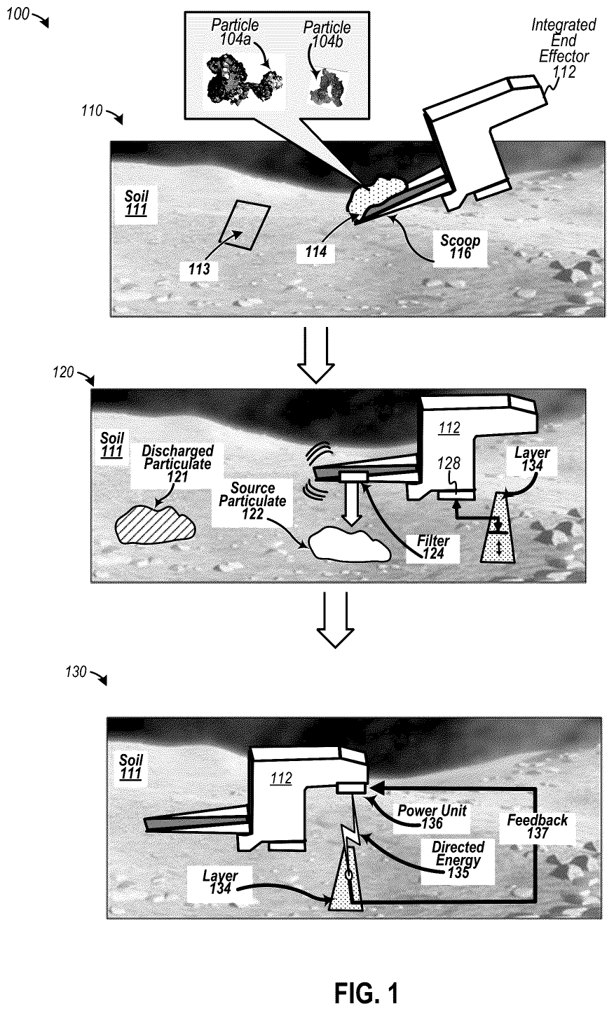

FIG. 1 is a diagram depicting an example of a device configured to implement a subset of indigenous particulate to form a structure in-situ, according to some embodiments. Diagram 100 depicts examples of a device configured to identify particulate for acquisition, to select a subset of particulate, and to form additive layers from which a structure may be constructed additively. In diagram 100, an example of a device is an integrated end effector 112 configured to perform exemplary functions or operations shown as operation 110, operation 120, and operation 130, at least in some cases. Integrated end effector 112 may be configured to perform each of operations 110, 120, and 130 any number of times and may be further configured to perform other functions or operations not depicted in diagram 100. In at least some examples, integrated end effector 112 may include a power unit 136 that includes one or more lasers configured to direct programmable energy to an unenclosed filtered indigenous particulate in a vacuum. Integrated end effector 112 may be configured to form structures, such as habitats, residences, roads, landing pads (e.g., lander and rocketry landing pads), blast shields, semi-open structures (e.g., hangers or garages), as well as any other structure formable in-situ with integrated end effector 112.

In operation 110, integrated end effector 112 may be configured to identify via sensors a portion 113 of a worksite associated with soil 111 from which to collect particulate. Integrated end effector 112 is shown to include a scoop 116 configured to extract or obtain indigenous particulate 114 from soil 111. As shown, integrated end effector 112 is in a state at which particulate 114 is scooped up or otherwise extracted. An example of particulate 114 may be composed of particles 104a and particles 104b, whereby particles 104a and 104b may be regolith, such as non-terrestrial regolith including lunar regolith, planetary regolith (e.g., Mars regolith), asteroid regolith, or the like. Particulate 114 may include any other combination of any solid material, such as rock-like particles of any size and possibly combined with any mineral or element and may be characterized based on its composition. For example, particles 104a and particles 104b, as constituents of particulate 114, may be characterized by agglutinate content or amounts of associated solar wind gases. Note that while a scoop 116 is shown, any other mechanism or means to extract particulate 114 may be performed by integrated end effector 112, such as by any mechanical or robotic grasping techniques, as well by any other means (e.g., vacuuming up particulate 114 into integrated end effector 112). Thus, integrated end effector 112 need not be limited to implement scoop 116 to extract particulate 114. In various examples, soil 111 may include non-terrestrial soil, such as lunar soil and planetary soil, as well as terrestrial soil (e.g., particulate 114 may include terrestrial particles in some implementations).

In operation 120, integrated end effector 112 may be configured to select one or more subsets of particulate from extracted particulate 114 to include in formation of additively constructed structures. In this example, scoop 116 may include a filter 124 configured to filter out (i.e., select) at least one subset of extracted particulate 114 as a source particulate 122. While not shown, non-filtered portions of extracted particulate 114 may remain in scoop 116. The non-filtered particulate may be deemed discardable, and thus integrated end effector 112 may be configured to move to spatially discard the non-filtered particulate into a collection or pile of discharged particulate 121 at a location suitably away from a worksite as which a structure is being formed. In some examples, filter 124 may be configured to selectively separate one or more subsets of source particulate 122. Filter 124 may also include any number of filters each of which being configured to filter a specific subset of source particulate 122. In some examples, filter 124 may be configured to select source particulate 122 as a function of particle size. For example, filter 124 may be configured to filter particles less than 1 mm in one or more dimensions. So, if particle 104b is less than 1 mm and particle 104a is greater than 1 mm, filter 124 may function to select particle 104b as source particulate 122 and may further select particle 104a as discharged particulate 121. Note that one or more filters 124 may operate to select particulate at any size. Further, filter 124 may be configured to filter or select source particulate 122 on characteristics other than size. For example, filter 124 may be configured to select source particulate 122 as a function of mineral composition or any other characteristic.

Further to operation 120, scoop 116 of integrated end effector 112 may collect a portion of source particulate 122 and deposit or dispense that portion of source particulate 122 at a target location of a worksite. For example, integrated end effector 112 may dispense source particulate 122 in a linear form as a layer 134. Note, however, integrated end effector 112 is not limited to dispensing source particulate 122 in a linear form but can deposit source particulate 122 in any geometric shape, such as a curved or arcuate form, or any other shape for any layer 134. Once formed, one or more layers 134 may include various linear layers and/or layers having various degrees of curvature. Hence, integrated end effector 112 may be configured to additively manufacture a structure of any variation of vertical and horizontal dimensions.

Also, integrated end effector 112 may be configured to compress or tamp source particulate 122 that is dispensed as a layer 134 to remove or decrease spaces among particles 104b (i.e., increase density of selected regolith). As shown in operation 120, integrated end effector 112 may include a compression surface unit 128, which, in some cases, may be a surface (e.g., the bottom) of a chassis configured to apply a force to compress or tamp layer 134.

At operation 130, integrated end effector 112 is shown to include a power unit 136 to apply directed energy 134 to each dispensed and compressed layer of one or more layers 134, whereby any number of layers 134 may be formed upon each other additively (e.g., 3D printed). In a non-limiting example, power unit 136 may be configured to apply directed energy 135 to layer 134 as a dispensed and compressed layer to transition corresponding source particulate 122 from a first solid state (e.g., as lunar regolith) to a molten state at a first point in time at a first temperature. In some examples, source particulate 122 in a molten state may be formed as an amorphous glass, which may be degassed and homogeneous as a molten liquid. Layer 134 in a molten state may transition into a second solid state, as an annealed solid, that may result in an amorphous glass layer. Also, layer 134, as an annealed solid, may be degassed, homogeneous, and a non-crystalline or quasi-crystalline sub-structure at a second point in time and at a second temperature (e.g., after directed energy 135 is directly applied and/or a temperature of layer 134 decreases). Thereafter, as a function of temperature and time, layer 134 in a solid state may transition into a state of crystallization. Integrated end effector 112 and power unit 136 are configured to induce crystallization from nucleation so that layer 134 results in an implementable state, such as a ceramic-glass sub-structure, at a third point in time and at a third temperature (or at any other time or temperature).

In some examples, integrated end effector 112 may receive feedback 137 as sensor data so that integrated end effector 112 may monitor application of energy (and temperature at layer 134) against a thermal profile (or any other characteristic) to determine whether application of a level of directed energy 135 absorbed at layer 134 conforms with operational tolerances, such as a thermal profile. If non-conformance is determined, integrated end effector 112 may be configured to adapt levels of energy applied to layer 134 to control and induce crystallization optimally to form a ceramic-glass sub-structure (or an equivalent thereof). In some examples, feedback 137 may be generated if a type of source particulate 122 that is receiving directed energy 135 is not producing a layer in accordance with a thermal profile. For example, a combination of certain types of regolith may not track a thermal profile or schedule. Directed energy 135 may be adapted based on feedback 137 to ensure optimal crystallization.

In various examples, power unit 136 may include one or more lasers

configured to apply energy for absorption by filtered regolith-in a vacuum-to cause the filtered regolith of source particulate 122 to increase in temperature sufficient to enter a molten state, whereby optimal crystallization may be managed. In one embodiment, operation 130 may include activating one or more lasers as power unit 136 to cause compressed source particles 122 in layer 134 to obtain a temperature sufficient to enter a molten state. As layer 134 transitions to a solid amorphous state to an implementable state (e.g., a ceramic-glass state), layer 134 may receive indirect energy from one or more lasers directing energy to other layers formed on layer 134. According to various embodiments, integrated end effector 112 may alternate between (1.) depositing and compressing a layer, which may be formed on another layer in operation 120 and (2.) activating one or more lasers to transfer energy into a layer in operation 130, whereby timing and temperature may be controlled by integrated end effector 120 to promote optimal crystallization.

In some embodiments, integrated end effector 112 may be configured to perform laser-based vitreous material transform (or “VMX”) to form glassy ceramic or equivalents thereof. In some examples, one or more lasers may be configured to deliver energy for absorption by particulate to increase temperatures of, for example, lunar regolith to 2,000 degrees Celsius. In some examples, one or more lasers may provide temperatures in a range of 800 to 1,600 degrees Celsius. Further, integrated end effector 112 and lasers of power unit 136 may be configured to direct energy through a space in a vacuum, whereby the space (i.e., distance between one or more lasers and workpiece, such as source particulate 122 in a layer) is unenclosed and without enclosed walls, objects, or structures, such as a chamber. Integrated end effector 112 and one or more lasers are configured to generate sub-structures (e.g., of ceramic-glass) with which to build upon at vacuum pressures from atmospheric pressures (e.g., 760 Torr) to 10⁻³ Torr. In some examples, integrated end effector 112 and one or more lasers may be configured to operate in pressures from atmospheric to 10⁻⁸ Torr to 10⁻¹⁰ Torr depending, for example, on lunar temperatures and radiant sunlight heating.

As described, integrated end effector 112 is adaptable to form sub-structures using with particulates having a wide variety of characteristics and properties (and sometimes unknown) by, for example, adapting levels of laser energy (and other laser characteristics like frequency characteristics) in a vacuum. By doing so, integrated end effector 112 can adapt laser-generated temperatures to control a rate of crystallization of layers of source particulate 122 to form optimal implementable sub-structures (e.g., ceramic-class sub-structures). Hence, resultant layers, sub-structures, and structures may have relatively low or negligible coefficients of thermal expansion (“CTE”), or linear CTE, in accordance with ASTM standards (e.g., ASTM standard E228) of West Conshohocken, Pennsylvania. Relatively low or negligible CTE values indicate robustness under thermal conditions, such on a lunar surface as temperature may fluctuate +/−300 degrees Celsius. Additionally, integrated end effector 112 is configured to filter or sort particulate 114 of imprecisely known qualities to enhance abilities to form sub-structures using laser energy unenclosed in a vacuum. In various examples, the term “sub-structure” may refer to a unit of a structure or may be used interchangeably with the term “structure.” Also, in some examples, the term “layer” may, as a sub-structure, be referred to as a structure. The terms layer, sub-structure, and structure may be interchangeable. Any of the structures and/or functionalities described herein are not limited to a specific environment and are applicable terrestrially as well as non-terrestrially.

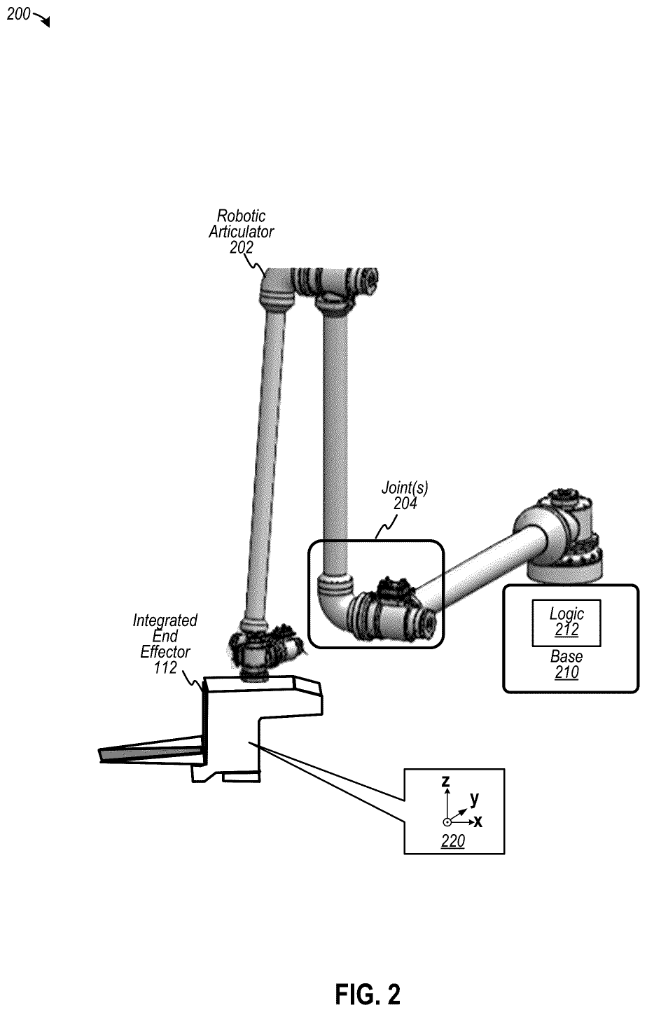

FIG. 2 is a diagram depicting an example of an integrated end effector coupled to a robotic articulator, according to at least one example. Diagram 200 includes an integrated end effector 112 coupled to a robotic articulator 202, which, in turn is coupled to a base 210. As shown, robotic articulator 202 may include any number of rotatable joints 204 to provide, for example, 4 to 8 degrees of freedom. In some cases, robotic articulator may implement six (6) joints 204. Robotic articulator 202 may provide integrated end effector 112 with an ability to travel or traverse distances at any radius about base 210. Further, robotic articular 202 can manipulate integrated end effector 112 to position or orient its scoop (or any other component including its lasers) in any position or orientation in frame of reference 220. In some cases, robotic articulator 202 may include a dust jacket (not shown) and umbilical cables and lines, including power and communications for integrated end effector 112. According to one example, base 210 may be a lander regardless of whether being stationary or mobile. Base 210 may also include logic 212 with which to provide processing capabilities for controlling integrated end effector 112 as a function of sensor data received from integrated end effector 112. Logic 212 includes hardware or software, or any combination thereof, to execute programmable instructions to operate integrated end effector 112. Also, logic 212 may include a transceiver to communicate over long distances (e.g., between earth and moon). Note, however, integrated end effector 112 may include logic configured to implement some of all functions provided by logic 212.

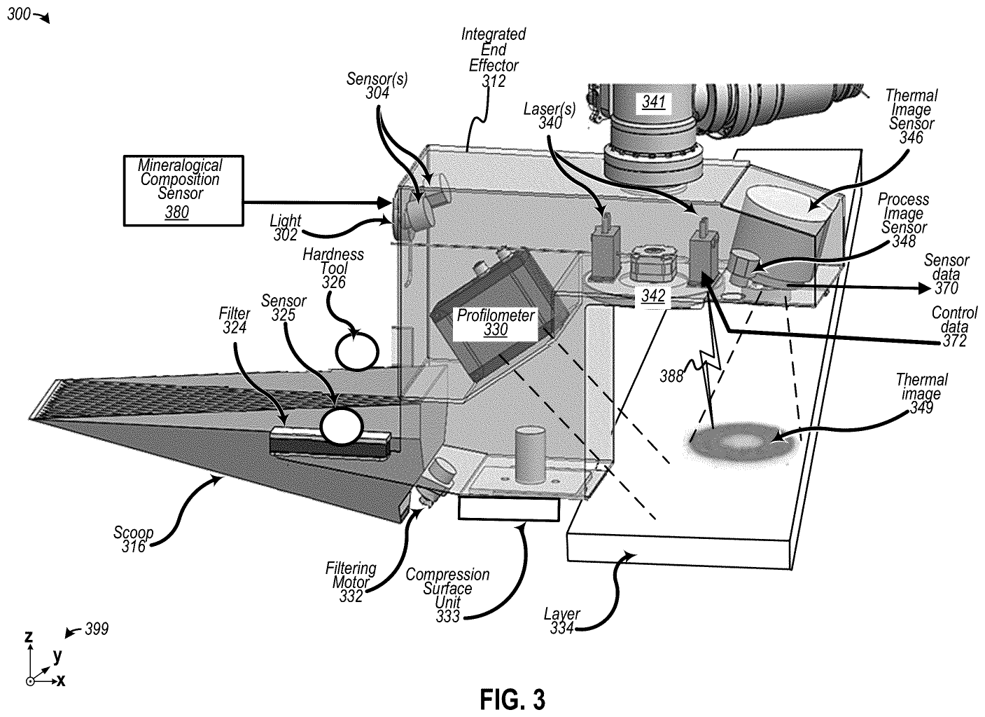

FIG. 3 is a perspective view of an example of an integrated end effector, according to some embodiments. Diagram 300 includes an integrated end effector 312 including a scoop 316 associated with a filter 324, a compression surface unit 333, one or more lasers 340, and an interface 341 to couple mechanically and electrically to a robotic articulator, any of which may be structurally and/or functionally of similarly referenced elements described above. Interface 341 enables a robotic articulator to articulate integrated end effector 312 in any number of degrees of freedom (e.g., 6 or more DOF).

In a first function performed by integrated end effector 312, as described in FIG. 1, scoop 316 may be configured to collect and extract raw particulate, such as lunar regolith. Scoop 316 is shown to be coupled to a filtering motor 332, which may be configured to impart mechanical energy to modify a spatial position of scoop 316 relative to other portions of the integrated end effector 312. As such, filtering motor 332 may urge scooped particulate toward filter 324. In some examples, filtering motor 332 may be implemented as a vibratory feed motor. Note that filter 324 may be configured to filter, discharge, or select one or more subsets of source particulates. In some cases, filter 324 may be configurable to select characteristics with which to separate particulates, or filter 324 may include multiple sub-filters each tuned to filter based on certain characteristics. For example, filter 324 may be configured to adjust filtering based on particulate size so that filter 324 may adjust filtering sizes from 2 mm to sub-millimeter sizes. Filter 324 may filter particulate based on other characteristics, such as a detected type of mineral fragment.

During filtering, a sensor in a group of sensor(s) 304 may be implemented as an image capture device (e.g., a camera) to detect a relative positioning of particulate in scoop 316 and generate a sensor data signal identifying the positioning. In response, a robotic articulator may cause scoop 316 to be oriented more positively in the Z-axis of frame of reference 399 with a rotation along the X-axis to funnel extracted particulate toward filter 324. Integrated end effector 312 may include sensor 325, which may be any type of sensor. In one example, sensor 325 may be an acoustic sensor configured to detect flow of filtered particulate to determine whether filtering is substantially completed. Scoop 316 may also include a hardness tool 326 to determine relative degrees of hardness of an object at a worksite external to integrated end effector 312. Integrated end effector 312 is shown to include a light 302 to provide illumination or enhancements for image recognition for sensors 304 to detect a portion of a worksite from which particulate, such as regolith, may be collected. Sensors 304 may be activated to scan a worksite to identify an object or objects that ought to be removed. For example, large obstructions relative to filtering or weathered regolith layers may be found present at a worksite. Therefore, scoop 316 may be implemented to remove objects or undesirable particulate to reduce impediments when extracting particulate. An optional mineral composition sensor 380 may be included to detect a type or an amount of a certain minerals and can generate a sensor signal indicating information regarding a detected mineral. In some cases, mineral composition sensor 380 may be implemented on base 210 of FIG. 2.

Referring back to FIG. 3, in a second function performed by integrated end effector 312, as described in FIG. 1, scoop 316 may be configured to collect source particulate (e.g., targeted regolith) that has been filtered through filter 324. In a third function performed by integrated end effector 312, as described in FIG. 1, scoop 316 may be configured to dispense or deposit source particulate in an alignment for forming a layer that is to be implemented as a sub-structure of a structure. In a fourth function, as described in FIG. 1, integrated end effector 312 may implement compression surface unit 333 to compress or tamp deposited source particulate to form a layer.

In a fifth function, integrated end effector 312 implements one or more other components to transition source particulate in layer 334 from a first solid state (e.g., as lunar regolith) to a molten state, and then to a second solid state (e.g., as an annealed solid). Thereafter, nucleation may be controlled by integrated end effector 312 to transform layer 334 through optimal crystallization based on controlled temperatures and controlled time to produce a layer 134 as a sub-structure. For example, upon determining a layer of filtered particulate has been deposited, integrated end effector 312 may be oriented in frame of refence 399 to process that layer of filtered particulate (e.g., filter regolith) to form a sub-structure (e.g., a ceramic-glass structure) upon which a structure may be constructed.

As shown in diagram 300, integrated end effector 312 includes a thermal image sensor 346, a process image sensor 348, a profilometer 330, and a lens carousel 342, as well as the aforementioned lasers 340. While any number of lasers 340 may be implemented, diagram 300 depicts two lasers 340 that apply energy to layer 334 to cause source particulate (e.g., regolith) to “melt” and crystalize and form an implementable state (e.g., a ceramic-glass sub-structure). In some examples, lasers 340 may provide equivalent or varied amounts of power from 180 watts to 1000 watts, or greater (e.g., 8000 watts). Lasers 340 may provide laser energy at wavelengths in the infrared range, such as in the range of approximately 1064 nm, or any other ranges of wavelengths. Laser 340 may include a laser diode array and integrated optics, or any other laser energy source.

A lens carousel 342 includes a transparent protective lens through which laser light may pass and is designed to protect laser 340 from receiving heated (and potentially damaging) particulate that may eject (e.g., as ejecta) from a surface of layer 334 in the lasing process. Lens carousel 342 may include a motor configured to rotate a lens should lasing efficiency decrease due to occlusions. Process image sensor 348 may be implemented to determine alignment and position of laser energy 388 relative to the surface of layer 334. Also, process image sensor 348 can provide sensor data representing feedback to adjust position of lasers 340 of integrated end effector 312 to bring the lasers 340 into alignment. Profilometer 330 is configured to scan the surface of layer 334 to identify non-conforming dimensions, such as whether a hole or a variance in height or depth may exist. If an abnormality is detected, integrated end effector 312 may be configured to remedy the abnormality (e.g., generating sensor feedback to instruct integrated end effector 312 to repair a non-conforming hole).

Integrated end effector 312 is shown to include a thermal image sensor 346 configured to monitor characteristics of thermal image 349 representing laser energy 388 impacting a surface of layer 334, whereby thermal image sensor 346 may be configured to detect one or more ranges of wavelengths (e.g., infra-red or any other ranges of wavelengths). Thermal image 349 generated by thermal image sensor 346 may indicate temperature values and gradients local to the lasing process. In some instances, composition of source particulate (e.g., regolith) in layer 334 may generate a thermal image 349 that may indicate that more or less laser energy may be applicable, and, if so, thermal image sensor 346 may generate a sensor data signal 370. Responsive to sensor data signal 370, logic (e.g., logic 212 of FIG. 2) may generate control data 372 to modify functionality of lasers 340, such as adapting power levels, modifying wavelengths, etc. Therefore, sensor data from thermal image sensor 346 may be used to modify or adapt temperatures at the surface of layer 334, which, in turn, assists in controlling nucleation and crystallization of source particulate as it forms into, for example, a ceramic-glass sub-structure. Controlling temperatures at a surface of layer 334 enables an ability to achieve enhanced quality of the composition of layer 334 post-process.

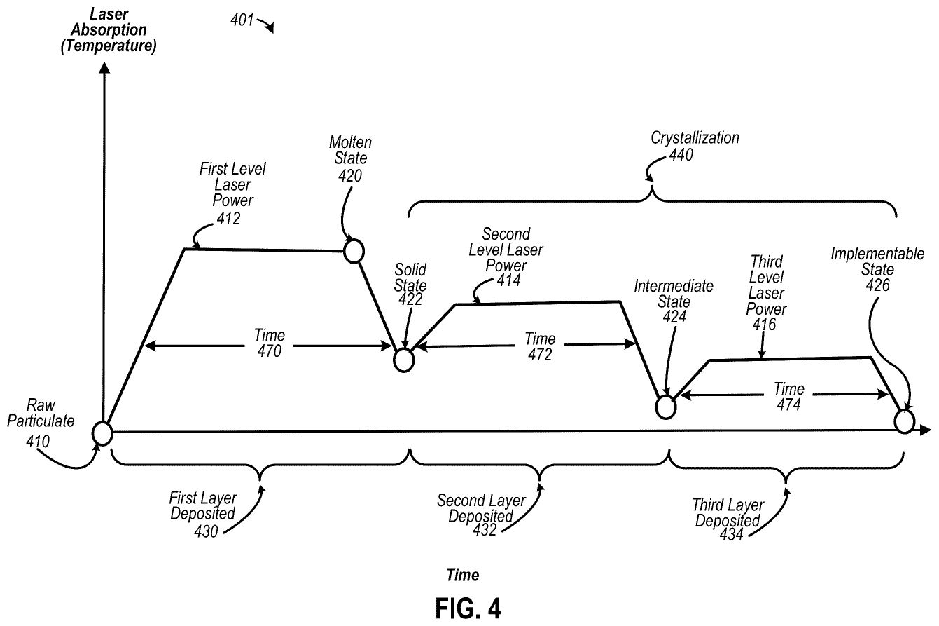

FIG. 4 illustrates an example of a thermal profile for a layer of particulate during application of laser energy, according to some examples. Diagram 400 depicts a thermal profile 401 or temperature schedule against which laser energy absorption and temperatures at a source particulate may be monitored and controlled to optimize nucleation and crystallization of the base materials to optimize formation of an implementable sub-structure (e.g., a ceramic-glass sub-structure). In some examples, diagram 400 depicts a thermal profile 401 for a layer undergoing application of direct laser energy with subsequent exposure to indirect laser energy as other layers of particulate are deposited, compressed, and subjected to an amount of laser energy as experienced by the layer associated with thermal profile 401. Thermal profile 401 may be implemented as data representing laser absorption energy (temperature) for a source particulate as a function of time.

Thermal profile 401 includes presentation of raw particulate 410 to a process of receiving laser energy in accordance with processes described herein. For example, a first layer of source particulate associated with thermal profile 401 has been filtered, deposited, and compressed and is receiving laser energy during a time shown as a first layer deposited 430. As shown, the temperature of the first layer increases under first level laser power 412, which is applied within time 470. Laser energy application may cease or be reduced at a point in time during time 470, with source particulate of the first layer transitioning to a molten state at 420. At time 470, the layer first transitions to a solid state 422 at which source particulate is annealed as an amorphous glass with at least some degrees of homogeneity.

A second layer is deposited and compressed over the first layer during time 432 and the second layer may receive a first level laser power 412 (unless integrated end effector adjusts the power level since the first layer). The first layer receives the laser energy as second level laser power 414 as the second layer may be translucent. At the time shown on thermal profile 401, the first layer is under a process of crystallization 440. Advantageously, at least in the example shown, the received laser energy of second level laser 414 promotes homogeneity and crystallization. Also, the second layer deposited on the first layer may provide insulative effects for the first layer, which, in turn, enhances crystallization. In some cases, the thermal energy of the first layer received during time 470 may transfer to the second layer, thereby requiring less application of laser power to the second layer during time 472.

A third layer is deposited and compressed over the second and the first layers during time 434. Also, the third layer may receive a first level laser power 412 (unless integrated end effector adjusts the power level since the first layer). As the third and second layers may be translucent, the first layer at an intermediate state may receive a third level of laser power 416 indirectly, which promotes homogeneity and crystallization as described for the second layer. Approximately at the end of time 474, the first layer may transition into an implementable state 426. In various examples, the first layer is formed as a ceramic-glass structure suitable for implementation to additively construct structures, such as landing pads.

In view of thermal profile 401, an integrated end effector including a thermal image sensor and one or more controllable lasers may be configured to adapt levels of laser energy applied to a subset of indigenous particulate to form structures in a vacuum in-situ. For example, a thermal image sensor may detect whether a temperature associated with first level laser power 412 may be lower or higher than expected due to a variance, for example, based on a type or quantity of source particulate (e.g., a type or quantity of regolith). As the variance may affect quality during crystallization 440, output of one or more lasers may be adapted or calibrated to align temperatures with thermal profile 401 to optimize crystallization 440 in formation of a ceramic-glass sub-structure or any other sub-structure. Integrated end effector may also be configured to modify times 470, 472, and 474 to optimize crystallization.

Note that thermal profile 401 may be varied and is not limited to that shown in diagram 400. For example, fewer or more applications of laser power at 412, 414, and 416 may be implemented, such as fourth level laser power application cycle. Also, in some examples, other thermal profiles 401 may be implemented at other temperatures and times based on a specific type of particulate (e.g., regolith) undergoing application of laser energy.

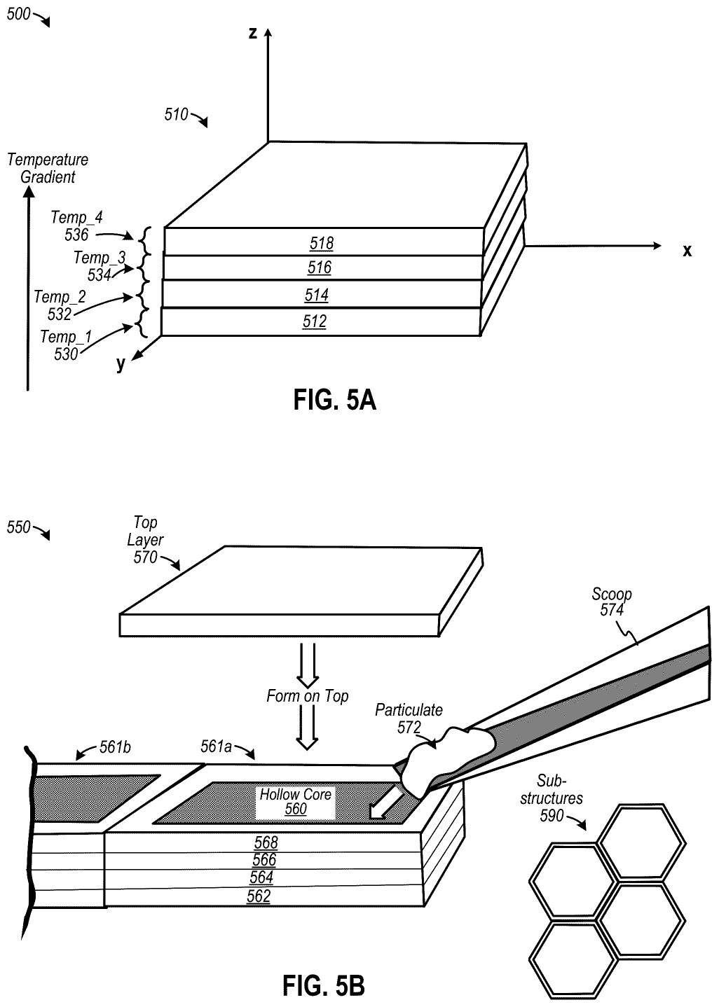

FIGS. 5A and 5B depict exemplary structures or sub-structures additively constructed, according to some examples. FIG. 5A is a diagram 500 that depicts a structure or a sub-structure 500 formed using an integrated end effector in accordance with processes and techniques described herein. Layers 512, 514, 516, and 518 (and possibly more) may be formed by: (1) extracting particulate, (2) filtering particulate, (3) depositing particulate, (4) compressing particulate, and (5) applying energy to particulate to change its state, as described above. Consider that layer 512 is the first layer described in FIG. 4 and may have a temperature (“temp_1”) 530, and layer 514 is formed thereupon. Layer 514 may be associated with temperature (“temp_2”) 532, which may be higher than temperature (“temp_1”) 530 as layer 514 receives less laser energy while transferring thermal energy to layer 514. Similarly, as layers 516 and 518 are formed, respective temperature (“temp_3”) 534 and temperature (“temp_4”) 536 may have thermal interactions equivalent to layers 512 and 514. As shown in diagram 500, a structure/sub-structure 510 is formed with a composition of ceramic-glass, at least in some cases. However, in accordance with the systems and processes described herein, structure/sub-structure 510 may be composed of any material and is not limited to ceramic-glass.

FIG. 5B is a diagram of another example of a structure or sub-structure that may be additively constructed. Diagram 550 depicts a structure or sub-structure 561a that may be constructed with layers 562, 564, 566, and 568 in which each layer may not be monolithic. Specifically, layers 562, 564, 566, and 568 are constructed additively as forms having a hollow core 560. Further to diagram 550, a scoop 574 may be configured to deposit particulate 572 in hollow core 560, whereby particulate 572 may include source particulate (e.g., filtered regolith). But particulate 572 need not be source particulate (i.e., need not be filtered regolith) as in this case particulate 572 may provide load-bearing structural support and need not be subjected to a lasing process. An integrated end effector may be configured to compress or tamp particulate 572 deposited in hollow core 560.

One or more top layers 570 may be formed similar to layers 512 to 518

on top of structure or sub-structure 561a. Further, structure or sub-structure 561a may be formed as part of grid-like structure, with a portion of a neighboring structure or sub-structure 561b shown. Note that a structure, like a road, make be composed of a grid of multiple implementations of structures or sub-structures 561a and 561b. Further, structure or sub-structure 561a need be limited to a rectangular “brick-like” shape but may formed with any shape or form. For example, structures or sub-structures 561a and 561b may be formed as depicted in a top view of sub-structures 590.

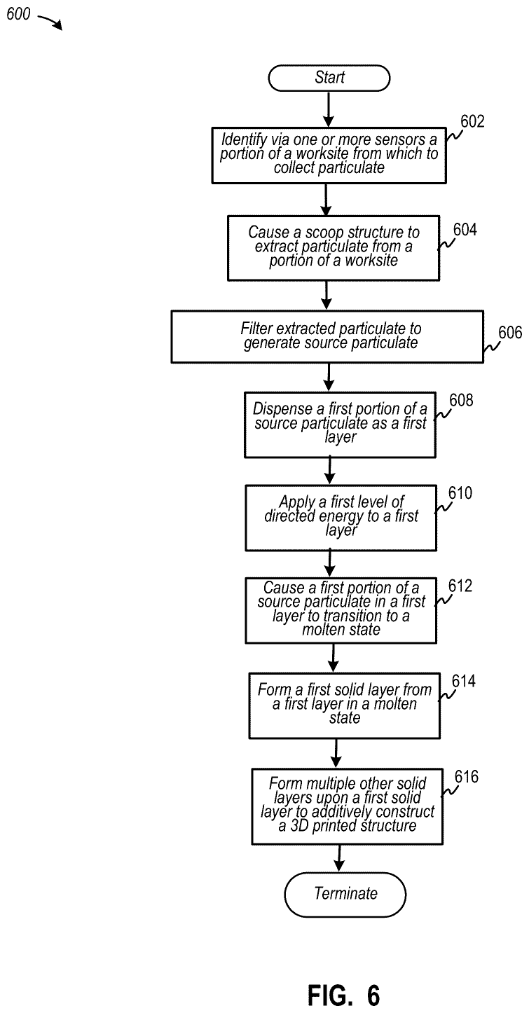

FIG. 6 depicts an example flow with which to form a structure or sub-structure, according to some embodiments. Flow 600 initiates at 602, a portion of a worksite from which to collect particulate may be identified via one or more sensors. At 604, a scoop structure may be activated to extract particulate from a portion of a worksite. At 606, extracted particulate may be filtered to generate source particulate. At 608, a first portion of a source particulate may be dispensed as a first layer. At 610, a directed energy of a first level may be applied to a first layer. At 612, a first portion of a source particulate in a first layer may transition to a molten state based on the directed energy applied thereto.

At 614, a first solid layer is formed from a first layer that was in a molten state. At 616, multiple other solid layers may be formed upon a first solid layer to additively construct a 3D printed structurer.

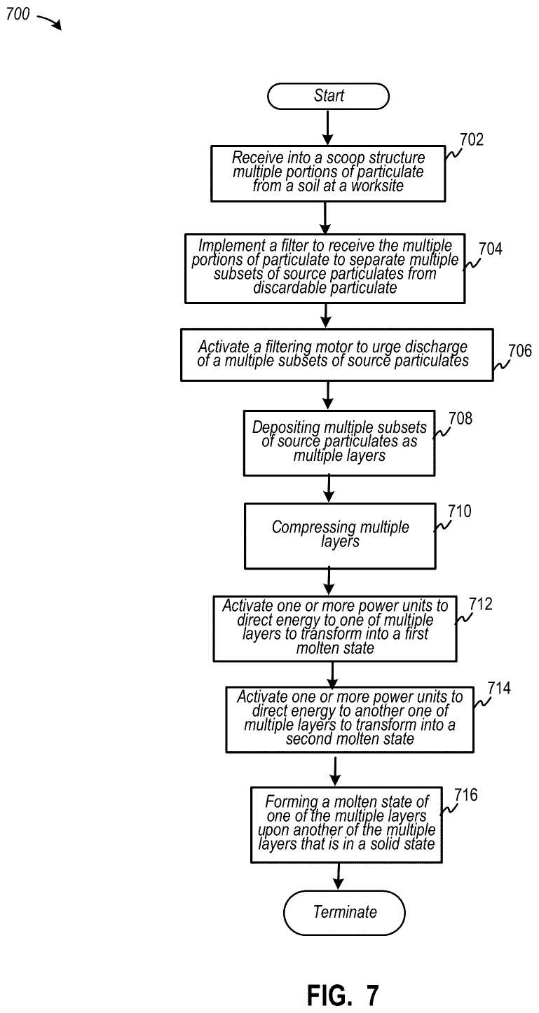

FIG. 7 depicts another example flow with which to form multiple structures or sub-structures, according to some embodiments. Flow 700 initiates at 702, a scoop structure may receive multiple portions of particulate from a soil at a worksite. For example, a scoop structure may repeatedly scoop up particulate form a sufficient amount of source material. In some examples, source material may include optimal types of regolith. At 704, a filter to receive multiple portions of particulate (e.g., over time) may be implemented to select separate multiple subsets of source particulates (e.g., over time) from discardable particulate. At 706, a filtering motor may be activated to urge discharge of a multiple subsets of source particulates, whereby each discharge may be sequential. At 708, multiple subsets of source particulates may be deposited as multiple layers, wherein each subset of source particulates may be deposited on each other in accordance with additive construction. At 710, multiple layers may each be compressed individually or any number of multiples. At 712, one or more power units may be activated to direct energy to one of multiple layers to transform into a first molten state. At 714, one or more power units may be activated to direct energy to another one of multiple layers to transform into a second molten state. At 716, a molten state of one of the multiple layers may be formed upon another of the multiple layers that is in a solid state.

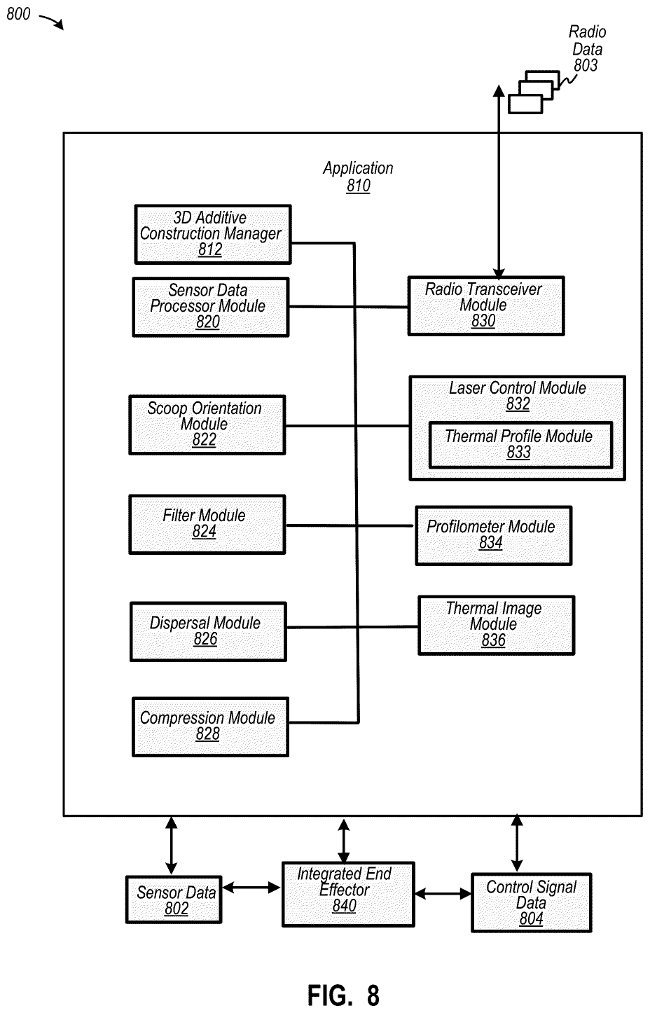

FIG. 8 illustrates an exemplary application architecture for controlling in-situ application of adaptive levels of energy applied to a subset of indigenous particulate to form structures in a vacuum, according to some examples. Diagram 800 is shown to include an application 810 including modules configured to provide functionalities based on at least sensor data 802 received from an integrated end effector 850, and the modules are further configured to generate control signal data 804 to control operation of integrated end effector 840. Structurally, in some examples, application 810, and the elements shown and described may be implemented as hardware, software, firmware, logic-specific circuitry, or as a combination thereof, without restriction or limitation to any particular implementation environment, 3D printing manufacturing process (or any other suitable manufacturing process), or configuration to form structure like shelters, houses, buildings, roads, hangers, landing pads, blast shields, etc. Modules implemented in application 810 with substantially similarly reference numbers or names may function similar to the other elements shown and described herein, including FIG. 1 and any other figure.

As shown in diagram 800, application 810 may include a 3D additive construction manager 812, a sensor data processor module 820, a scoop orientation module 822, a filter module 824, a dispersal module 826, a compression module 828, a radio transceiver module 830, a laser control module 832, which may include thermal profile module 833, a profilometer module 834, and a thermal image module 836, among others.

3D additive construction manager 812 may be configured to control and coordinate operation and functionalities of other modules to manage operation of an integrated end effector, whereby 3D additive construction manager 812 may manage communications and transmissions of control signal data 804 generated by other modules. Further, 3D additive construction manager 812 may include logic configured to access data representing source code to generate one or more structures (e.g., data files in G-Code or the like), and may further include logic configured to control operation of a robotic actuator to position and orient an integrated end effector to perform functions described herein.

Sensor data processor module 820 may be configured to receive a variety of subsets of sensor data 802 from any number of sensors, such as, but not limited to, one or more image capture devices (e.g., cameras) including a process image sensor, one or more thermal cameras, one or more profilometers, sensors related to one or more lasers (e.g., thermal data, etc.), sensors related to a filtering motor (e.g., vibratory frequency to confirm operational), acoustic sensors, sensors related to a hardness tool (e.g., a Schmidt hammer), sensors relating to a lens carousel (e.g., to confirm operation). Other sensor data may be received from inertial measurement units (“IMUs”) that identify forces, angular rate of change, accelerations, rates of speed, position data relative to an integrated end effector, and the like for a robotic actuator. Additional sensor data from a robotic actuator may be received from light detection and range sensors (“Lidar”), acoustic sensors, ultrasonic sensors, radar, pressure sensors, gyros, and the like.

Scoop orientation module 822 may receive commands to position and orient scoop to extract particulate, filter particulate, deposit particulate, compress particulate, apply energy via lasers to a particulate to change its state, among other functionalities. Filter module 824 may be configured to initiate filtering by generating commands to an integrated end effector to manage operation of a filtering process. Dispersal module 826 may be configured to initiate deposition of source particulate in preparation to receive compression forces, which, by commanded by compression module 828.

Radio transceiver module 830 may be configured to exchange radio communications wirelessly via radio data 803 and may be conduit between an integrated end effector and a remote location (e.g., Austin, TX). Radio data 803 may include executable instructions as code, sensor data, etc. Laser control module 832 may be configured to control operation of one or more lasers, such as modifying power, modifying wavelengths, etc. Laser control module 832 may also include a thermal profile module 833 configured to access data representing a thermal profile or a temperature schedule to monitor laser outputs and data from a thermal image camera. Profilometer module 834 may be configured to monitor and control a profilometer, as well as generating data representing issues with a profile or surface of a layer being formed. Thermal image module 836 may be configured to monitor and control a thermal image camera, as well as processing data from the thermal image camera to coordinate laser operation with laser control module 832.

Note that each of the modules of application 810 may interact electronically with each other to correlate and/or combine functionalities to provide for material deposition using indigenous particulate. Further, any module may communicate internally or externally with other applications or other computing platforms via, for example, an application programming interface (“API”).

Any of the described modules of FIG. 8 or any other processes described herein in relation to other figures may be implemented as software, hardware, firmware, circuitry, or a combination thereof firmware, logic-specific circuitry, or as a combination thereof, without restriction or limitation. Any of modules of FIG. 8 may be disposed, placed, distributed, or arranged in a base, such as base 210 of FIG. 2, or any module may be distributed at other portions of a system other than in a base, such as in an integrated end effector.

If implemented as software, the described techniques may be implemented using various types of programming, development, scripting, or formatting languages, frameworks, syntax, applications, protocols, objects, or techniques, including, but not limited to, “G-Code,” Python™, ASP, ASP.net, .Net framework, Ruby, Ruby on Rails, C, Objective C, C++, C #, Adobe® Integrated Runtime™ (Adobe® AIR™), ActionScript™, Flex™, Lingo™, Java™, JSON, Javascript™, Ajax, Perl, COBOL, Fortran, ADA, XML, MXML, HTML, DHTML, XHTML, HTTP, XMPP, PHP, and others, including SQL™, SPARQL™, Turtle™, etc., as well as any proprietary application and software provided or developed by ICON Technology, Inc., or the like. The above-described techniques may be varied and are not limited to the embodiments, examples, or descriptions provided.

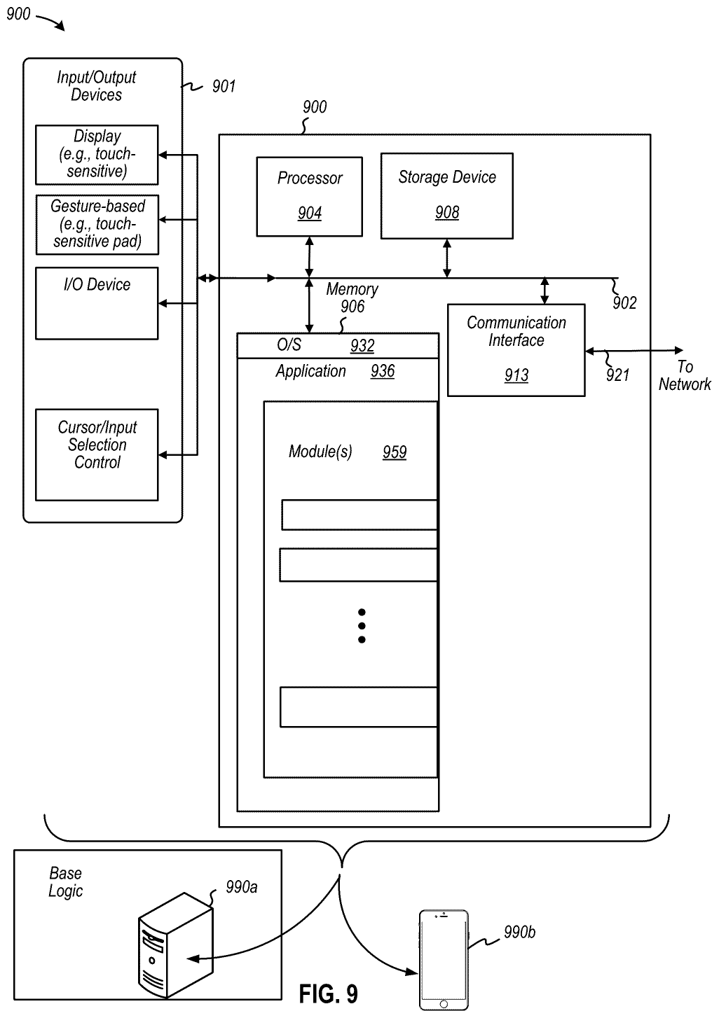

FIG. 9 illustrates examples of various logic and computing platforms configured to provide various functionalities to components of a base unit, such as a lander of FIG. 2, configured to provide functionalities described herein.

FIG. 9 illustrates examples of various computing platforms configured to provide various functionalities to components of a computing platform 900 configured to provide functionalities described herein. Computing platform 900 may be used to implement computer programs, applications, methods, processes, algorithms, or other software, as well as any hardware implementation thereof, to perform the above-described techniques.

In some cases, computing platform 900 or any portion (e.g., any structural or functional portion) can be disposed or located in any device, such as a computing device 990a, mobile computing device 990b, and/or a processing circuit in association with initiating any of the functionalities described herein, via user interfaces and user interface elements, according to various examples.

Computing platform 900 includes a bus 902 or other communication mechanism for communicating information, which interconnects subsystems and devices, such as processor 904, system memory 906 (e.g., RAM, etc.), storage device 908 (e.g., ROM, etc.), an in-memory cache (which may be implemented in RAM 906 or other portions of computing platform 900), a communication interface 913 (e.g., an Ethernet or wireless controller, a Bluetooth controller, NFC logic, etc.) to facilitate communications via a port on communication link 921 to communicate, for example, with a computing device, including mobile computing and/or communication devices with processors, including database devices (e.g., storage devices configured to store relational data, structured data, unstructured data, and graph data or atomized datasets, including, but not limited to triple stores, etc.). Processor 904 can be implemented as one or more graphics processing units (“GPUs”), as one or more central processing units (“CPUs”), such as those manufactured by Intel® Corporation, or as one or more virtual processors, as well as any combination of CPUs and virtual processors. Or, a processor may include a Tensor Processing Unit (“TPU”), or equivalent. Computing platform 900 exchanges data representing inputs and outputs via input-and-output devices 901, including, but not limited to, keyboards, mice, audio inputs (e.g., speech-to-text driven devices), user interfaces, displays, monitors, cursors, touch-sensitive displays, touch-sensitive inputs and outputs (e.g., touch pads), LCD or LED displays, and other I/O-related devices.

Note that in some examples, input-and-output devices 901 may be implemented as, or otherwise substituted with, a user interface in a computing device associated with, for example, a user account identifier in accordance with the various examples described herein.

According to some examples, computing platform 900 performs specific operations by processor 904 executing one or more sequences of one or more instructions stored in system memory 906, and computing platform 900 can be implemented in a client-server arrangement, peer-to-peer arrangement, or as any mobile computing device, including smart phones and the like. Such instructions or data may be read into system memory 906 from another computer readable medium, such as storage device 908. In some examples, hard-wired circuitry may be used in place of or in combination with software instructions for implementation. Instructions may be embedded in software or firmware. The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks and the like. Volatile media includes dynamic memory, such as system memory 906.

Known forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can access data. Instructions may further be transmitted or received using a transmission medium. The term “transmission medium” may include any tangible or intangible medium that is capable of storing, encoding, or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by computing platform 900. According to some examples, computing platform 1500 can be coupled by communication link 921 (e.g., a wired network, such as LAN, PSTN, or any wireless network, including WiFi of various standards and protocols, Bluetooth®, NFC, Zig-Bee, etc.) to any other processor to perform the sequence of instructions in coordination with (or asynchronous to) one another. Computing platform 900 may transmit and receive messages, data, and instructions, including program code (e.g., application code) through communication link 921 and communication interface 913. Received program code may be executed by processor 904 as it is received, and/or stored in memory 906 or other non-volatile storage for later execution.

In the example shown, system memory 906 can include various modules that include executable instructions to implement functionalities described herein. System memory 906 may include an operating system (“O/S”) 932, as well as an application 936 and/or logic module(s) 959. In the example shown in FIG. 9, system memory 906 may include any number of modules 959, any of which, or one or more portions of which, can be configured to facilitate any one or more components of a computing system (e.g., a client computing system, a server computing system, etc.) by implementing one or more functions described herein.

The structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. These can be varied and are not limited to the examples or descriptions provided.

In some embodiments, modules 959 of FIG. 9, or one or more of their components, or any process or device described herein, can be in communication (e.g., wired or wirelessly) with a mobile device, such as a mobile phone or computing device, or can be disposed therein.

In some cases, a mobile device, or any networked computing device (not shown) in communication with one or more modules 959 or one or more of its/their components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figures can represent one or more algorithms. Or, at least one of the elements can represent a portion of logic including a portion of hardware configured to provide constituent structures and/or functionalities.

For example, modules 959 or one or more of its/their components, or any process or device described herein, can be implemented in one or more computing devices (i.e., any mobile computing device, such as a wearable device, such as a hat or headband, or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, modules 959 or one or more of its/their components, or any process or device described herein, can be implemented in one or more computing devices that include one or more circuits. Thus, at least one of the elements in the above-described figures can represent one or more components of hardware. Or, at least one of the elements can represent a portion of logic including a portion of a circuit configured to provide constituent structures and/or functionalities.

According to some embodiments, the term “circuit” can refer, for example, to any system including several components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

1. A method comprising:
identifying via one or more sensors at an integrated end effector a portion of a worksite from which to collect particulate;
causing a scoop structure to extract particulate from the portion of the worksite to form extracted particulate;
filtering the extracted particulate to generate source particulate;
dispensing a first portion of the source particulate at a target portion of the worksite to form a first layer;
applying a directed energy at a first level to the first layer to transition to a molten state; and
forming a first solid layer from the first layer in the molten state with which to form a three-dimensional (“3D”) structure.

2. The method of claim 1 wherein the particulate includes at least a portion of regolith particles and the source particulate includes at least a portion of source regolith.

3. The method of claim 1 wherein applying the directed energy further comprises:
activating one or more lasers to cause the first portion of source particulate to absorb laser energy and increase a temperature to a first temperature.

4. The method of claim 1 wherein applying the directed energy further comprises:
activating one or more lasers to direct laser energy through a space in a vacuum.

5. The method of claim 4 wherein the space is unenclosed.

6. The method of claim 1 wherein dispensing the portion of the first source particulate at the target portion of the worksite further comprises:
compressing the first portion of the source particulate associated with the target portion of the worksite.

7. The method of claim 1 further comprising:
dispensing a second portion of the source particulate upon the first solid layer at the target portion of the worksite to form a second layer.

8. The method of claim 7 further comprising:
applying a second level of directed energy to the first layer to cause the first portion of the source particulate in the first layer to transition to a crystallization state.

9. The method of claim 7 further comprising:
activating the one or more lasers to cause the second portion of source particulate in the second layer to absorb laser energy to increase a temperature to a second temperature.

10. The method of claim 1 further comprising:
activating one or more sensors to scan the worksite to identify an object other than the particulate; and
removing the object from the worksite.

11. A system comprising:
an integrated end effector comprising:
a scoop structure configured to receive multiple portions of particulate from a soil at a worksite;
a filter coupled to the scoop structure and configured to receive the multiple portions of particulate to separate multiple subsets of source particulates from discardable particulates;
a filtering motor coupled to the scoop structure and configured to modify a spatial position of the scoop structure relative to other portions of the integrated end effector to urge discharging the multiple subsets of source particulates;
a compression surface unit configured to compress deposited layers of the multiple source particles in multiple layers; and
one or more power units configured to direct energy the multiple layers to transform the multiple layers into multiple molten states.

12. The system of claim 11 wherein the integrated end effector is configured to form the compressed deposited layers multiple layers upon each other,
wherein at least a subset of the multiple molten states is formed sequentially.

13. The system of claim 11 wherein the one or more power units comprises:
one or more lasers configured to direct the energy a distance including a vacuum.

14. The system of claim 13 wherein the distance including the vacuum is unenclosed.

15. The system of claim 13 further comprising;
a thermal image sensor configured to detect directed energy absorption at one of the multiple layers and to generate data representing the directed energy absorption.

16. The system of claim 13 wherein the one or more lasers are configured to modify operating characteristics responsive to data representing directed energy absorption.

17. The system of claim 11 wherein the filtering motor is a vibratory motor.

18. The system of claim 11 wherein the integrated end effector further comprises:
a profilometer configured to detect surface characteristics of the first layer.

19. The system of claim 11 further comprising:
a robotic articulator interface coupled to a robotic articulator configured to position and orient the integrated end effector spatially in one or more of an X-axis, a Y-axis, and a Z-axis.

20. A system comprising:
a memory including executable instructions; and
a processor, responsive to executing the instructions, is configured to:
identify via one or more sensors at an integrated end effector a portion of a worksite from which to collect particulate;
cause a scoop structure to extract particulate from the portion of the worksite to form extracted particulate;
filter the extracted particulate to generate source particulate;
dispense a first portion of the source particulate at a target portion of the worksite to form a first layer;
apply a directed energy at a first level to the first layer to transition to a molten state; and
cause formation of a first solid base layer from the first layer in the molten state with which to form a three-dimensional (“3D”) structure.
